(19) United States
(12) Patent Application Publication
(10) Pub. No.: US 2018/0162226 A1
(43) Pub. Date: Jun. 14, 2018

(54) SYSTEM AND METHOD FOR DETERMINING REGENERATIVE BRAKING MODE OF LDC

(71) Applicants: HYUNDAI MOTOR COMPANY, Seoul (KR); KIA MOTORS CORPORATION, Seoul (KR)

(72) Inventors: Dong Jun SHIN, Hwaseong-si (KR); Ho Joong Lee, Anyang-si (KR); Chang Ryeol Yoo, Incheon (KR)

(21) Appl. No.: 15/831,064

(22) Filed: Dec. 4, 2017

(30) Foreign Application Priority Data
Dec. 14, 2016 (KR) 10-2016-0170609

(51) Int. Cl. B60L 7/16; B60L 11/18; B60L 7/18; B60L 15/20; B60T 8/172

(52) U.S. Cl. CPC B60L 7/16; B60L 11/1861; B60L 7/18; B60L 15/2018; B60T 8/172; B60T 2270/60; B60L 2240/12; B60L 2240/54; B60L 2240/42; B60L 2240/526; B60L 2210/10

(57) ABSTRACT

A system for determining a regenerative braking mode (regen mode) of a LDC to determine an entrance into the regen mode or a release from the regen mode among driving modes of the LDC includes a vehicle speed calculating device that detects a driving speed of a vehicle and outputs information on the detected driving speed, an inclination sensing device that detects an inclination of a road on which the vehicle is driving and outputs information on the detected inclination, and a processor that determines the entrance into the regen mode and the release from the regen mode, based on the driving speed of the vehicle and the inclination of the road at a time point that a high-voltage battery is fully charged.

### CROSS-REFERENCE TO RELATED APPLICATION

This application is based on and claims the benefit of priority to Korean Patent Application No. 10-2016-0170609, filed on Dec. 14, 2016, with the Korean Intellectual Property Office, the entire disclosure of which is incorporated herein by reference.

### TECHNICAL FIELD

The present disclosure relates to a system and a method for determining a regenerative braking mode (hereinafter, “regen mode”) of a low DC-DC converter (LDC), and more particularly, to a technology of determining entrance into and release from the regen mode of a vehicle.

### BACKGROUND

In general, a hybrid vehicle refers to a vehicle driven by efficiently combining two types of power sources which are mutually different from each other. In most cases, the hybrid vehicle is driven by an engine by combusting a fuel (e.g., fossil fuel such as gasoline) and an electric motor by using battery power for providing rotational force to the vehicle.

Such a hybrid vehicle is a future vehicle capable of reducing exhaust gas and improving fuel efficiency by employing the electric motor as an auxiliary power source, in addition to the engine. Accordingly, the hybrid vehicle has been more actively studied and researched in line with the demand for improving the fuel efficiency and for developing an eco-friendly product.

The hybrid vehicle obtains driving force only by the driving motor when starting or driving at a low speed. When an initial start is made, the engine represents the efficiency lower than the efficiency of the motor. Accordingly, it is advantageous in terms of the fuel efficiency of the vehicle to make the initial start of the vehicle by using the driving motor representing higher efficiency than that of the engine. Accordingly, after the vehicle starts off, a starter generator (that is, a hybrid starter & generator (HSG)) which provides rotational force (that is, outputs cranking torque) to the engine starts up the engine. Therefore, engine power and motor power may be simultaneously used.

As described above, the hybrid vehicle drives in different driving modes, such as an electric vehicle (EV) mode, which is a pure electric vehicle mode of employing only rotational force of the driving motor drive the vehicle, and a hybrid electric vehicle (HEV) mode of employing the rotational force of the engine as main power while employing the rotational force of the driving motor as auxiliary power. In the hybrid vehicle, a mode change from the EV mode to the HEV mode is made due to the startup of the engine by an integrator starter generator (ISG).

The mode change between the EV mode and the HEV mode is one of the main functions in the hybrid vehicle and serves as a factor influencing the driving performance, the fuel efficiency, and the power performance of the hybrid vehicle. In the case of a full hybrid vehicle, the control of an on/off mode (HEV/EV mode) of an engine is optimized and thus a fuel consumption may be reduced.

In particular, a technology of reducing the fuel consumption of the hybrid vehicle is demanded in the case of determining entrance into or release from a driving mode provided in the hybrid vehicle when the hybrid vehicle drives along a downhill or on a flat road.

### SUMMARY

The present disclosure has been made to solve the above-mentioned problems occurring in the prior art while advantages achieved by the prior art are maintained intact.

An aspect of the present disclosure provides a system and a method for determining a regenerative braking mode (regen mode) of an LDC, capable of controlling and compensating for threshold values to determine an entrance into and a release from the regenerative braking mode according to the speed and the inclination of a vehicle, thereby entering into the regenerative braking mode of the vehicle to charge an auxiliary battery with power even if a high-voltage battery is fully charged with power when the vehicle drives along a downhill.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a system for determining a regen mode of a LDC includes a vehicle speed calculating device that detects a driving speed of a vehicle and outputs information on the detected driving speed, an inclination sensing device that detects an inclination of a road on which the vehicle is driving and outputs information on the detected inclination, and a processor that compensates for threshold values to determine the entrance into the regen mode and the release from the regen mode, respectively, based on the driving speed of the vehicle and the inclination of the road at a time point that a high-voltage battery is fully charged.

According to an embodiment, the processor may calculate the threshold values to be compensated for to determine the entrance into the regen mode and the release from the regen mode by using a motor power threshold value, which is set for the entrance into the regen mode according to the driving speed of the vehicle, and a compensation map according to the driving speed of the vehicle and the inclination of the road.

According to an embodiment, the vehicle speed calculating device may calculate an average speed at a preset time interval if the vehicle does not cruise.

According to an embodiment, the inclination sensing device may have values for compensating for the motor power of the vehicle according to the entrance into the regen mode and the release from the regen mode.

According to another aspect of the present disclosure, a method for determining a regen mode of an LDC includes steps of determining a time point that a high-voltage battery is fully charged, determining whether a present driving mode of the LDC is the regen mode, if the high-voltage battery is fully charged, and calculating threshold values compensated for to determine the entrance into the regen mode and the release from the regen mode according to a driving speed of a vehicle and inclination of a road at the time point that the high-voltage battery is fully charged, if the present driving mode of the LDC is not a regen mode.

According to an embodiment, the step of determining a time point that the high-voltage battery is fully charged may include comparing a power limit for charging the high-voltage battery with a preset reference value.

According to an embodiment, the method may further include a step of comparing a state of charge (SOC) and a temperature of an auxiliary battery with a preset SOC and a preset temperature of the auxiliary battery between the step of determining a time point that the high-voltage battery is fully charged and the step of determining whether a present driving mode of the LDC is the regen mod.

According to an embodiment, the method may further include a step of determining a fuel injection state of the vehicle between the step of determining whether a present driving mode of the LDC is the regen mode and the step of calculating threshold values.

According to an embodiment, the method may further include steps of, comparing present motor power with the threshold value compensated for to determine the entrance into the regen mode, after the step of calculating threshold values, and entering into the regen mode if the present motor power is equal to or less than the threshold value compensated for to determine the entrance into the regen mode.

According to an embodiment, the method may further include steps of, comparing present motor power with the threshold value compensated for to determine the release from the regen mode, after the step of calculating threshold values and releasing the regen mode if the present motor power is equal to or greater than the threshold value compensated for to determine the release from the regen mode.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a system for determining a regen mode of an LDC, according to an embodiment of the present disclosure;

FIG. 2 is a flowchart illustrating a method for determining a regen mode of an LDC, according to an embodiment of the present disclosure;

FIG. 3 is a graph illustrating the compensation for the threshold values to determine the entrance into and the release from the regen mode when the system for determining the regen mode of the LDC determines the regen mode, according to an embodiment of the present disclosure;

FIGS. 4A and 4B are views illustrating paths of using the output voltage of the LDC before and after the time point that the threshold values to determine the entrance into and the release from the regen mode is compensated for when the system for determining the regen mode of the LDC determines the regen mode, according to an embodiment, of the present disclosure; and

FIG. 5 is a block diagram illustrating a computing system to execute the method for determining the regen mode of the LDC, according to an embodiment of the present disclosure.

### DETAILED DESCRIPTION

Various advantages and features of the present disclosure and methods accomplishing them will become apparent from the following description of embodiments made in detail with reference to accompanying drawings. However, the present disclosure is not limited to the embodiments described herein but may be embodied in other forms. The present embodiments are provided so that those skilled in the art can easily carry out the technical idea of the present disclosure.

In the drawings, the embodiments of the present disclosure are not limited to the specific forms shown and are exaggerated for the sake of clarity. Although specific terms are used herein, the terms are provided for the illustrative purpose and should not be used to limit the scope of the presented invention set force in the appended claims.

In the present specification, the term “and/or” is used as a meaning of including at least one of elements described in the following description. In addition, it will be understood that when an element is referred to as being “connected” or “coupled” to another element, it may be directly connected or coupled to the another element or intervening elements may be present therebetween. In the present specification, the singular forms are intended to include the plural forms as well, unless the context clearly indicates otherwise. In addition, the statement of elements, steps, operations, and devices followed by the terms “comprises” and/or “comprising”, which is used in the present specification refers to that at least one of other elements, steps, operations, and devices is present or added.

Hereinafter, an embodiment of the present disclosure will be described with reference to accompanying drawings.

A low DC-DC converter (LDC) may have a configuration of determining a driving mode by controlling a voltage in an LDC, a configuration of determining an output voltage in the LDC under the situation that the driving mode is determined, and a configuration of variably controlling the determined output voltage.

In particular, the configuration of determining the driving mode by controlling the voltage in the LDC may include a configuration of determining an electrical vehicle (EV) mode, a configuration of determining an engine charging mode, and a configuration of determining a regenerative braking (regen) mode.

Herein, the present disclosure relates to a system and a method for determining the regen mode, which have the configuration of determining the regen mode.

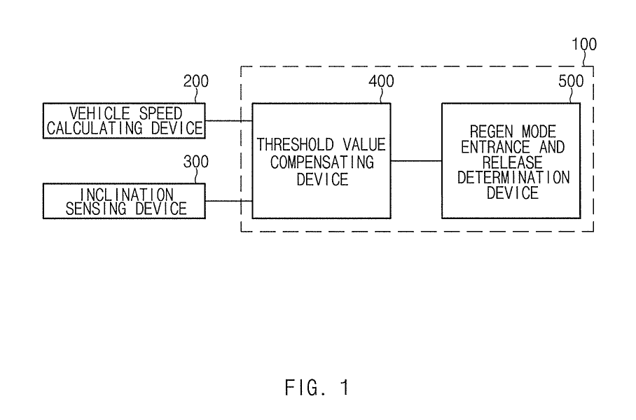

FIG. 1 is a block diagram illustrating the system for determining a regen mode of an LDC, according to an embodiment of the present disclosure.

Referring to FIG. 1, a system 100 for determining the regen mode includes a hardware processor including a threshold value compensating device 400 which compensates for threshold values to determine an entrance and a release from the regen mode, based on information received from a vehicle speed calculating device 200 and an inclination sensing device 300, and a regen mode entrance and release determination device 500.

The hardware processor performs various functions of following devices 400 and 500. The devices 400 and 500 described below are implemented with software instructions executed on the processor.

The vehicle speed calculating device 200 detects a driving speed of a vehicle by using sensors attached to the vehicle and transmits information on the detected driving speed. For example, the vehicle speed calculating device 200 detects a driving speed by using revolutions per minute (RPM) of an output shaft of a transmission or a wheel speed of each wheel and converts information on the driving speed into an electrical signal.

In the case that the vehicle does not cruise, the vehicle speed calculating device 200 calculates an average value (average speed) of the vehicle speed at a preset time interval and provides the calculation result which is the driving speed.

The inclination sensing device 300 may include a tilt sensor to detect the inclination (gradient) of a road, on which the vehicle is driving, and to provide the information of the inclination (gradient).

The threshold value compensating device 400, which determines the entrance into and the release from the regen mode, compensates for the threshold values to determine the entrance into and the release from the regen mode at a time point that a high-voltage battery is fully charged.

The threshold value compensating device 400 may calculate the threshold values to be compensated for to determine the entrance into the regen mode and the release from the regen mode by using a motor power threshold value, which is set for the entrance into the regen mode according to the driving speed of the vehicle, and a compensation map according to the driving speed of the vehicle and the inclination of the road.

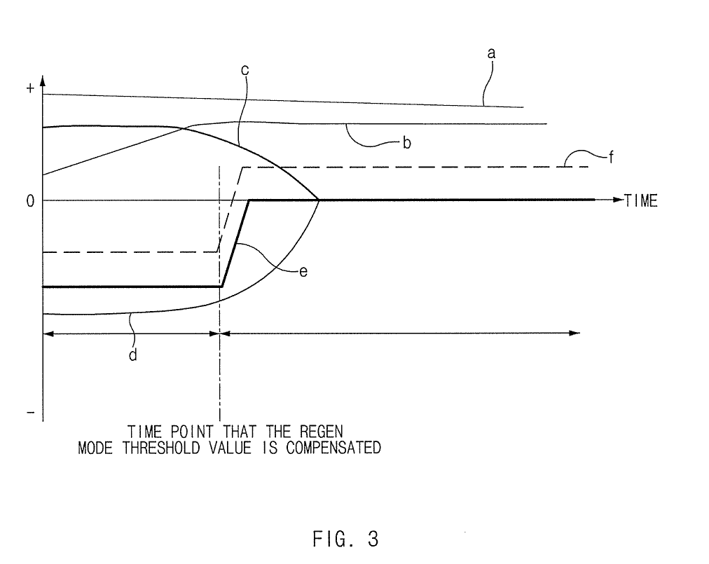

In other words, the threshold value compensating device 400, which compensates for the threshold values to determine the entrance into and the release from the regen mode, compensates for the threshold value to determine the entrance into or the release from the regen mode before the power of a motor (driving motor) is convergent to zero (“0”) (which is illustrated through the graph of FIG. 3 in detail).

The regen mode entrance and release determination device 500 finally determines the entrance into or the release from the regen mode by comparing the compensated threshold value with present motor power.

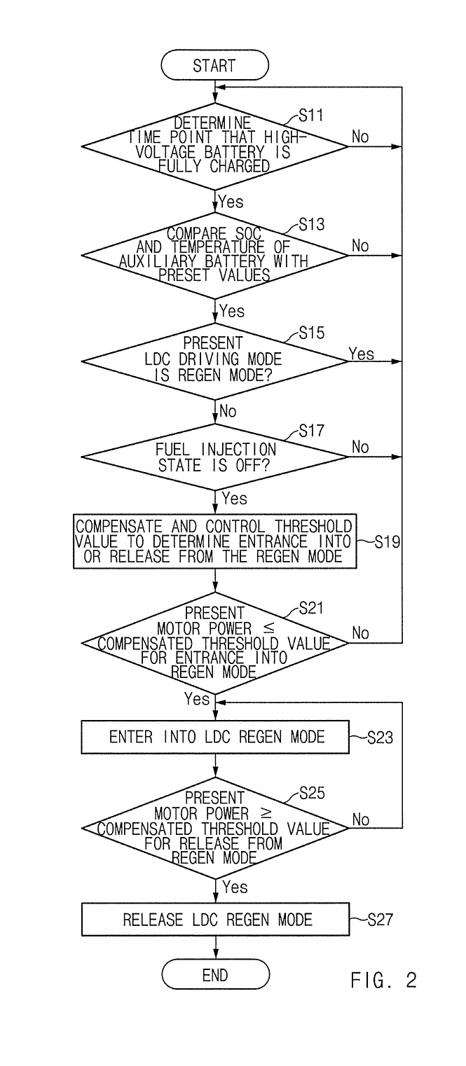

FIG. 2 is a flowchart illustrating a method for determining a regen mode of the LDC, according to an embodiment of the present disclosure.

According to the method for determining the regen mode of the LDC, it may be determined whether the LDC and an intelligent battery sensor (IBS) are in a normal operation state.

In other words, the normal operation status of the LDC is determined to determine whether the auxiliary battery and the electric load of the vehicle are supplied with power supplied while a motor for driving the vehicle is being decelerated during driving or idle charging is performed.

In addition, the normal operation status of the IBS is determined to normally output a state of charge (SOC) and a temperature of the auxiliary battery which are received.

Referring to FIG. 2, the LDC determines a time point that the high-voltage battery is fully charged with power (S11).

In other words, the LDC compares a high-voltage battery charge power limit with a set reference value.

In this case, the high-voltage battery charge power limit, which is a limitable value right before the high-voltage battery is fully charged, may be compared with a preset reference value.

In particular, the high-voltage battery charge power limit may be received from a battery management system through wireless communication (for example, controller area network (CAN) communication).

Next, the LDC compares the SOC and the temperature of the auxiliary battery with a preset SOC and a preset temperature of the auxiliary battery (S13).

In detail, if a present SOC of the auxiliary battery is less than the preset SOC of the auxiliary battery as the present SOC of the auxiliary battery is compared with the preset SOC of the auxiliary battery, the LDC compares a present temperature of the auxiliary battery with the preset temperature of the auxiliary battery.

In other words, if the present temperature of the auxiliary battery is less than the preset temperature of the auxiliary battery, the LDC determines whether a present LDC driving mode is a regen mode (S15).

Next, if the present LDC driving mode is not the regen mode, a fuel injection state into the vehicle is an off state (S17).

Thereafter, the LDC compensates for the threshold values to determine the entrance into and the release from the regen mode (S19).

Next, the LDC compares present motor power with the threshold value compensated to determine the entrance into the regen mode (S21).

Subsequently, if the present motor power is equal to or less than the threshold value compensated to determine the entrance into the regen mode, the regen mode entrance and release determination device allows the LDC to enter into the regen mode among driving modes of the LDC (S23).

Next, the LDC compares the present motor power with the threshold value compensated to determine the release from the regen mode (S25).

Subsequently, if the present motor power is equal to or greater than the threshold value compensated to determine the release from the regen mode, the regen mode entrance and release determination device allows the LDC to release from the regen mode among driving modes of the LDC (S27).

FIG. 3 is a graph illustrating the compensation for the threshold values to determine the entrance into and the release from the regen mode when the system for determining the regen mode of the LDC determines the regen mode, according to an embodiment of the present disclosure.

Referring to FIG. 3, an X axis represents time, and a Y axis represents a vehicle speed ‘a’, a high-voltage battery SOC ‘b’, a high-voltage battery charge power ‘c’, motor power ‘d’, a threshold value (threshold power, ‘e’) for the entrance into the regen mode after and before compensation, and a threshold value (threshold power, ‘f’) for the release from the regen mode before and after the compensation.

In detail, the following description is made regarding that the threshold value ‘e’ for the entrance into the regen mode before and after the compensation and the threshold value ‘f’ for the release from the regen mode before and after the compensation are changed before and after the time point that the regen mode threshold values are compensated for.

When the vehicle drives along the downhill, the vehicle speed ‘a’ is slowly decreased at a constant rate, the high-voltage battery SOC ‘b’ is increased till the time point that the regen mode threshold values are compensated for and then is maintained to the constant value, the high-voltage battery power ‘c’ is convergent to zero (“0”) from a plus value, and the motor power ‘d’ is convergent to zero (“0”) from a minus value.

In this case, the threshold value ‘e’ for the entrance into the regen mode before the compensation and the threshold value ‘f’ for the release from the regen mode before the compensation are sharply increased and then are maintained to a constant value after the time point that the regen mode threshold values are compensated.

In other words, after the time point that the regen mode threshold values are compensated, if the present motor power ‘d’ is equal to or less than the compensated threshold value for the entrance into the regen mode, the LDC enters into the regen mode. Alternatively, if the present motor power ‘d’ is equal to or greater than the compensated threshold value for the release from the regen mode, the LDC releases from the regen mode.

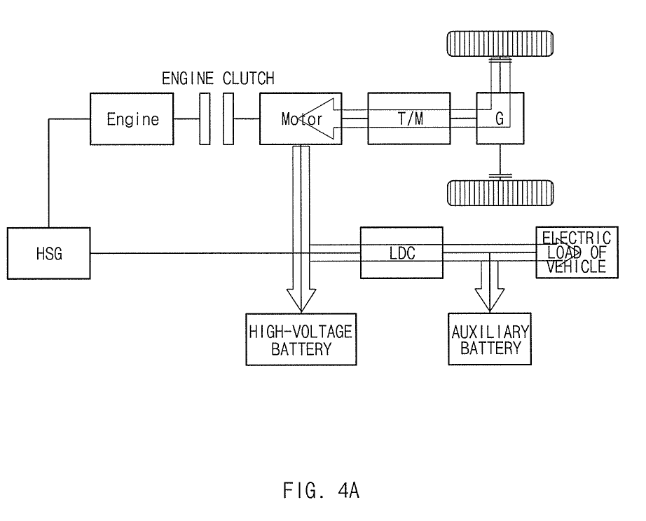

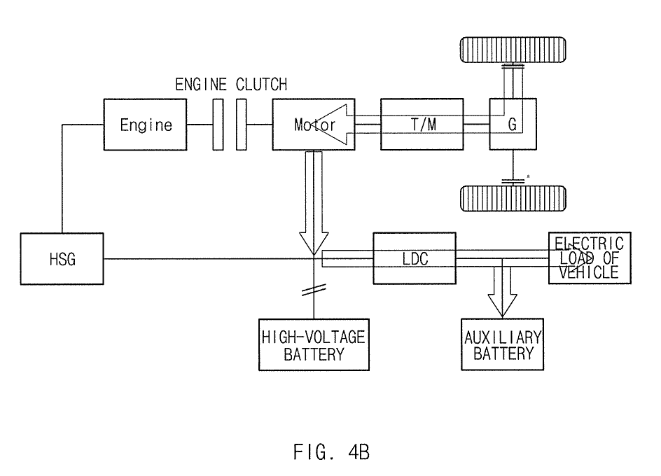

FIGS. 4A and 4B are views illustrating paths of using the output voltage of the LDC before and after the time point that the threshold values to determine the entrance into and the release from the regen mode are compensated for when the system for determine the regen mode of the LDC determines the regen mode, according to an embodiment of the present disclosure.

In other words, it is disclosed that the vehicle has a path of charging energy, which is generated through a gear ‘G’, a transmission ‘T/M’, and a motor, into the high-voltage battery or a path of supplying the energy to the electric load of the vehicle and the auxiliary battery through the LDC. In this case, the motor is coupled to an engine, an engine clutch is open/closed between the motor and the engine, and an HSG is coupled between the engine and the LDC.

Referring to FIG. 4A, before the time point that the regen mode threshold value is compensated for, the high-voltage battery is charged through the motor until being fully charged, and the auxiliary battery and the electric load are supplied with power through the LDC.

Referring to FIG. 4B, after the time point that the regen mode threshold value is compensated for, the high-voltage battery is not charged if being fully charged, and the auxiliary battery and the electric load are supplied with power through the LDC.

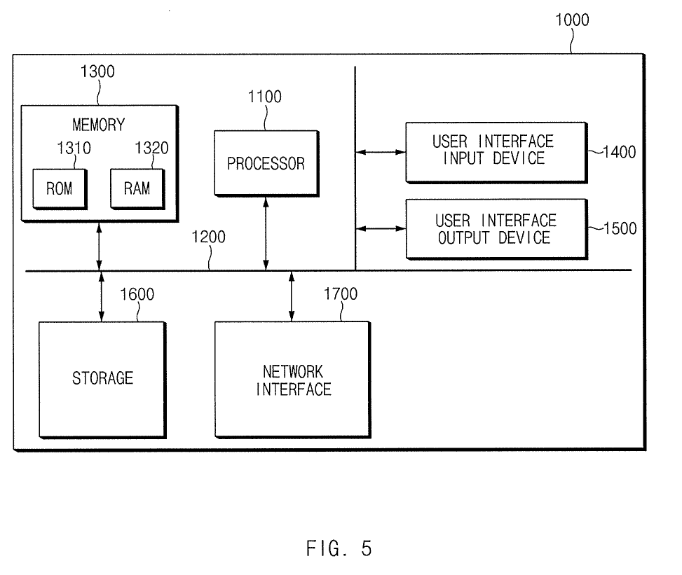

FIG. 5 is a block diagram illustrating a computing system to execute the method for determining the regen mode of the LDC, according to an embodiment of the present disclosure.

Referring to FIG. 5, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for processing instructions stored in the memory 1300 and/or the storage 1600. The memory 1300 and the storage 1600 may include various types of volatile or non-volatile storage media. For example, the memory 1300 may include a read only memory (ROM) and a random access memory (RAM).

Thus, the operations of the methods or algorithms described in connection with the embodiments disclosed in the present disclosure may be directly implemented with a hardware module, a software module, or combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM). The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and THE storage medium may reside as separate components of the user terminal.

According to the present disclosure, regenerative braking energy may be supplied to the auxiliary battery.

In addition, according to the present disclosure, when the vehicle drives along the downhill, the vehicle may enters into the regen mode to charge the auxiliary battery with power or to supply regenerative braking energy to the electric load of the vehicle. Accordingly, the fuel efficiency of the vehicle may be improved.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A system for determining a regenerative braking mode (regen mode) of a low DC-DC converter (LDC) to determine an entrance into the regen mode or a release from the regen mode among driving modes of the LDC, the system comprising:
a vehicle speed calculating device configured to detect a driving speed of a vehicle and to output information on the detected driving speed;
an inclination sensing device configured to detect an inclination of a road on which the vehicle is driving and to output information on the detected inclination; and
a processor configured to compensate for a threshold value to determine the entrance into the regen mode and the release from the regen mode, respectively, based on the driving speed of the vehicle and the inclination of the road at a time point that a high-voltage battery is fully charged.

2. The system of claim 1, wherein the processor calculates the threshold value compensated for to determine the entrance into the regen mode and the release from the regen mode by using a motor power threshold value, which is set for the entrance into the regen mode according to the driving speed of the vehicle, and a compensation map according to the driving speed of the vehicle and the inclination of the road.

3. The method of claim 1, wherein the vehicle speed calculating device calculates an average speed at a preset time interval if the vehicle does not cruise.

4. The method of claim 1, wherein the inclination sensing device has a value for compensating for motor power of the vehicle according to the entrance into the regen mode and the release from the regen mode.

5. A method for determining a regenerative braking mode (regen mode) of a low DC-DC converter (LDC) to determine an entrance into the regen mode or a release from the regen mode among driving modes of the LDC, the method comprising steps of:
determining a time point that a high-voltage battery is fully charged;
determining whether a present driving mode of the LDC is the regen mode, if the high-voltage battery is fully charged; and
calculating a threshold value compensated for to determine the entrance into the regen mode and the release from the regen mode according to a driving speed of a vehicle and inclination of a road at the time point that the high-voltage battery is fully charged, if the present driving mode of the LDC is not the regen mode.

6. The method of claim 5, wherein the step of determining a time point that the high-voltage battery is fully charged includes:
comparing a power limit for charging the high-voltage battery with a preset reference value.

7. The method of claim 5, further comprising a step of:
comparing a state of charge (SOC) and a temperature of an auxiliary battery with a preset SOC and a preset temperature of the auxiliary battery, between the step of determining a time point that the high-voltage battery is fully charged and the step of determining whether a present driving mode of the LDC is the regen mod.

8. The method of claim 5, further comprising a step of:
determining a fuel injection state of the vehicle between the step of determining whether a present driving mode of the LDC is the regen mode and the step of calculating a threshold value.

9. The method of claim 5, further comprising steps of:
comparing present motor power with the threshold value compensated for to determine the entrance into the regen mode, after the step of calculating a threshold value; and
entering into the regen mode if the present motor power is equal to or less than the threshold value compensated for to determine the entrance into the regen mode.

10. The method of claim 5, further comprising steps of:
comparing present motor power with the threshold value compensated for to determine the release from the regen mode, after the step of calculating a threshold value; and
releasing the regen mode if the present motor power is equal to or greater than the threshold value compensated for to determine the release from the regen mode.
